(19) United States
(12) Patent Application Publication
(10) Pub. No.: US 2026/0318271 A1
(43) Pub. Date: Oct. 15, 2026

(54) PISTON AND VARIABLE INJECTOR TO OPTIMIZE PERFORMANCE AND EMISSIONS OF A COMPRESSION IGNITION ENGINE

(71) Applicant: Deere & Company, Moline, IL (US)

(72) Inventor: Bryan T. Geisick, Cedar Falls, IA (US)

(21) Appl. No.: 19/177,294

(22) Filed: Apr. 11, 2025

(51) Int. Cl. F02M 61/10; F02M 61/18

(52) U.S. Cl. CPC F02M 61/10; F02M 61/18; F02M 2200/70

(57) ABSTRACT

A variable flow fuel injector system featuring a nozzle assembly with selectively activated outlet groups. The system incorporates a nozzle cavity extending along a central axis, transitioning from a main body through a narrowed neck region to a head section containing multiple strategically positioned outlet orifices. An axially translating injector needle cooperates with the nozzle cavity, featuring complementary body and neck geometries designed for precise flow control. A configurable travel stop mechanism selectively restricts needle movement away from the nozzle head, enabling distinct operating positions. In a first position, the needle engages the travel stop while permitting fuel flow through a primary outlet group. When the stop is disengaged, the needle achieves a second position enabling simultaneous flow through both primary and secondary outlet groups. This architecture provides precise control over spray patterns and flow characteristics across varying engine operating conditions.

### CROSS-REFERENCE TO RELATED APPLICATIONS

Not applicable.

### STATEMENT OF FEDERALLY SPONSORED RESEARCH OR DEVELOPMENT

Not applicable.

### FIELD OF THE DISCLOSURE

This disclosure relates to piston technology and fuel delivery systems for internal combustion engines, and more particularly, but not by way of limitation, to integrated piston bowl and variable injector configurations designed to optimize fuel combustion and engine performance.

### BACKGROUND OF THE DISCLOSURE

During design of a combustion system, many constraints and limits need consideration while trading emissions, performance, and efficiency. Many times, a combustion system does not perform optimally at every speed and load operation point, requiring compromise when selecting bowl shape, swirl, and fuel injector specifications. While modern engines incorporate additional flexibility in scheduling various amounts of injection pressure, timing, air flow, and exhaust gas recirculation flow to help broaden the optimized area of the operating space, parameters such as injector specifications (including number of nozzle holes, flow rates, and spray angles) remain fixed and limit achievable efficiencies. A single injector specification must be chosen as a compromise to satisfy operational constraints and limits throughout the engine's operating range. At different speed/load operating points, optimal injector specifications often vary significantly from one another.

### SUMMARY OF THE DISCLOSURE

A piston and variable injector to optimize performance and emissions of a compression ignition engine are disclosed. According to some embodiments, the present disclosure is directed to a fuel injector that includes a nozzle defining a nozzle cavity extending about a nozzle axis, the nozzle cavity having a nozzle body, a nozzle neck that narrows from the nozzle body, and a nozzle head extending from the nozzle neck and defining multiple nozzle outlets positioned differently with respect to the nozzle axis. The injector also includes an injector needle disposed in the nozzle cavity and movable along the nozzle axis, the injector needle having a needle body, a needle neck that narrows from the needle body.

The fuel injector assembly operates under high pressure regimes characteristic of compression ignition engines. The system maintains operational pressures sufficient for optimal fuel atomization and penetration across varying engine conditions. The nozzle outlets are precision-manufactured to tight tolerances, enabling controlled fuel delivery across multiple spray patterns while maintaining structural integrity under sustained high-pressure operation.

The injector also includes a travel stop configured and positionable to selectively impede movement of the injector needle along the nozzle axis in a direction away from the nozzle head so that the injector needle may translate along the nozzle axis between a first axial position and a second axial position, in the first axial position, the injector needle abuts the travel stop and allows flow to a first of the nozzle outlets, and, in the second axial position, the injector needle is clear of the travel stop and allows flow to the first nozzle outlet and a second of the nozzle outlets. Other embodiments of this aspect include corresponding computer systems, apparatus, and computer programs recorded on one or more computer storage devices, each configured to perform the actions of the methods.

Implementations may include one or more of the following features. The fuel injector where, in the first axial position, the injector needle opens a flow path to the first nozzle outlet, the flow path defined in part by a first internal flow passage leading from a first needle inlet in the needle body, the needle neck, or the needle head to a first needle outlet in the needle head. In the second axial position, the injector needle opens the first flow path to the second nozzle outlet. In the second axial position, the injector needle opens the flow path to the first and second nozzle outlets, the flow path defined in part by the first internal flow passage leading from the first needle inlet to the first needle outlet and by a second internal flow passage leading from a second needle inlet in the needle body, the needle neck, or the needle head to a second needle outlet in the needle head.

The nozzle outlets can be grouped into a first group of nozzle outlets including the first nozzle outlet and a second group of nozzle outlets including the second nozzle outlet; where the injector needle defines a second internal flow passage leading from the needle inlet to a second needle outlet, the first and second needle outlets communicating with the first group of nozzle outlets in the first axial position; and where the first and second needle outlets communicate with the first and second groups of nozzle outlets in the first axial position.

In the first axial position, the injector needle opens a first flow path leading to the first nozzle outlet, the first flow path defined in part between the needle neck and the needle head and the nozzle neck and the nozzle head. In the second axial position, the injector needle opens a second flow path to the second nozzle outlet, the second flow path defined in part by a second internal flow passage passing from a needle inlet in the needle body, the needle neck, or the needle head to a first needle outlet in the needle head that communicates with the second nozzle outlet.

In the second axial position, the injector needle opens the flow path to the first and second nozzle outlets, the flow path defined in part by the first internal flow passage leading from the first needle inlet to the first needle outlet and by a second internal flow passage leading from a second needle inlet in the needle body, the needle neck, or the needle head to the first needle outlet in the needle head.

In the second axial position, the injector needle is clear of the travel stop and abuts the second travel stop and, in the third axial position, the injector needle is clear of the travel stop and the second travel stop and allows flow to the first nozzle outlet, the second nozzle outlet, and a third of the nozzle outlets. In the third axial position, the injector needle opens a third flow path leading to the third nozzle outlet, the third flow path defined in part between the needle neck and the needle head and the nozzle neck and the nozzle head, including a reduced diameter section of the needle head.

The nozzle outlets are grouped into a first group of nozzle outlets including the first nozzle outlet, a second group of nozzle outlets including the second nozzle outlet, and a third group of nozzles including the third nozzle outlet.

In the first axial position, the injector needle opens the flow path to the first nozzle outlet, the flow path defined in part by a first internal flow passage leading from a first needle inlet in the needle body, the needle neck, or the needle head to the nozzle outlets; where, in the second axial position, the injector needle opens the flow path to the first and second nozzle outlets, the flow path defined in part by the first internal flow passage and a second internal flow passage leading from a second needle inlet in the needle body, the needle neck, or the needle head to the nozzle outlets; and where the second needle inlet is closer to a distal end of the nozzle head than the first needle inlet such that, in the first axial position, the first needle inlet is open to the nozzle outlets and the second needle inlet is closed off by the nozzle head and, in the second axial position, the first needle inlet and the second needle inlet are open to the nozzle outlets.

The injector needle allows more flow through the nozzle outlets in the first axial position than in the second axial position. The injector needle may translate along the nozzle axis to a null axial position in which the injector needle is clear of the travel stop and closes of flow to the nozzle outlets.

The travel stop is a bar disposed at an able to the nozzle axis and configured to selectively translate along a stop axis into and out of interference with translation of the injector needle along the nozzle axis. The travel stop is a solenoid which is electrically or hydraulically actuated. The travel stop includes multiple bars that effect at least two travel stops and which are independently movable into and out of interference with translation of the injector needle along the nozzle axis; and where a first travel stop is positioned to intersect the nozzle axis closer to the nozzle head than a second travel stop. Implementations of the described techniques may include hardware, a method or process, or computer software on a computer-accessible medium.

The details of one or more embodiments are set forth in the accompanying drawings and the description below. Other features and advantages will become apparent from the description, the drawings, and the claims.

### BRIEF DESCRIPTION OF THE DRAWINGS

At least one example of the present disclosure will hereinafter be described in conjunction with the following figures:

FIG. 1 is a simplified perspective view of an example work vehicle in the form of a wheel loader in which an engine having the disclosed piston and injector may be incorporated.

FIG. 2 illustrates a schematic representation of an internal combustion engine system, depicting integration of exhaust gas recirculation (EGR), fuel injection components, and thermal management elements including coolant routing pathways and associated control mechanisms.

FIG. 3 is a cross-sectional view of a piston assembly and variable fuel injector system, detailing the spatial relationship between injection components and combustion chamber geometry, including actuator coupling and controller interfaces.

FIG. 4 depicts internal component arrangements of a variable fuel injector assembly, highlighting upper and lower nozzle orifice configurations and associated flow passages.

FIG. 5 illustrates the variable fuel injector assembly during active fuel delivery, showing flow path trajectories and resultant spray patterns.

FIG. 6 presents the variable fuel injector assembly operating with multiple active nozzle groups, demonstrating simultaneous activation of upper and lower orifice sets.

FIG. 7 provides a top-down view of spray pattern distribution within the combustion bowl, illustrating the relationship between nozzle groups and targeted combustion zones.

FIG. 8 depicts the variable fuel injector assembly in Position Zero, illustrating complete nozzle sealing configuration.

FIG. 9 shows the injector nozzle tip in Position A, detailing partial activation state with specific nozzle group engagement.

FIG. 10 illustrates Position B configuration enabling multiple nozzle group activation and associated spray patterns.

FIG. 11 presents Position C operation showing full nozzle group activation and comprehensive spray pattern deployment.

FIG. 12 provides a top-down perspective of spray pattern interaction with combustion bowl geometry.

FIG. 13 illustrates high-flow operating configuration showing simultaneous activation of multiple nozzle groups.

FIG. 14 depicts multi-flow configuration emphasizing distinct spray pattern generation through selective nozzle group activation.

FIG. 15 is a schematic view of a hydraulic control system integration, including stop mechanism, solenoid valve, and controller interconnections supporting variable flow operation.

Like reference symbols in the various drawings indicate like elements. For simplicity and clarity of illustration, descriptions, and details of well-known features and techniques may be omitted to avoid unnecessarily obscuring the example and non-limiting embodiments of the invention described in the subsequent Detailed Description. It should further be understood that features or elements appearing in the accompanying figures are not necessarily drawn to scale unless otherwise stated.

### DETAILED DESCRIPTION

Embodiments of the present disclosure are shown in the accompanying figures of the drawings described briefly above. Various modifications to the example embodiments may be contemplated by one of skill in the art without departing from the scope of the present invention, as set forth in the appended claims.

### OVERVIEW

Modern internal combustion engine systems face fundamental challenges in optimizing combustion dynamics across diverse operational parameters. Conventional fuel delivery architectures, characterized by fixed injector configurations and symmetric piston bowl geometries, impose inherent limitations on combustion efficiency, thermal management, and emissions control. Specifically, predetermined injector specifications—including fixed nozzle configurations, invariable flow rates, and static spray geometries—create systematic constraints that impede optimal performance across the engine's operational envelope.

The present disclosure introduces an integrated injection and combustion management system incorporating variable-geometry fuel delivery mechanisms and asymmetric combustion chamber architectures. The system enables dynamic modulation of critical injection parameters, including but not limited to: volumetric flow rates, instantaneous injection pressures, spray cone geometries, and selective nozzle activation patterns. This adaptive architecture facilitates real-time optimization of injection characteristics in response to specific engine operational states, thereby enhancing combustion efficiency, reducing emissions formation, and improving thermal management.

Embodiments include selectively actuated nozzle group configurations, where discrete nozzle clusters operate independently based on precisely controlled needle positions achieved through adjustable travel stop mechanisms. This architecture enables targeted spray pattern modulation—for example, implementing reduced flow rates and narrower spray cones during partial-load operation to minimize particulate formation, while engaging broader spray patterns and increased flow rates during high-load conditions to maximize combustion efficiency.

The system's integration of variable injection control with asymmetric piston bowl geometries creates synergistic performance benefits. Specifically, the coordination between modulated spray patterns and non-uniform bowl sectors enables precise fuel distribution control, optimizing local air-fuel ratios and managing combustion progression. This configuration actively mitigates thermal concentration effects, reducing structural loading on critical components including cylinder heads and valve assemblies.

Additional advantages manifest in transient operating conditions, particularly during cold-start sequences. The variable-geometry system facilitates enhanced fuel atomization when combustion chamber temperatures are sub-optimal, promoting more complete combustion and accelerating thermal stabilization. This capability directly addresses cold-start emissions challenges while improving aftertreatment system performance.

The disclosed architecture has broad applications across various internal combustion engine platforms, from highway transportation to industrial power generation. By enabling dynamic adaptation to varying operational demands, the system provides a comprehensive solution for meeting increasingly stringent emissions requirements while maintaining optimal performance characteristics across the entire operating range.

The following sections provide detailed descriptions of embodiments and configurations, offering further insights into the structural and functional aspects of the disclosed injector designs and combustion systems.

### EXAMPLE EMBODIMENTS

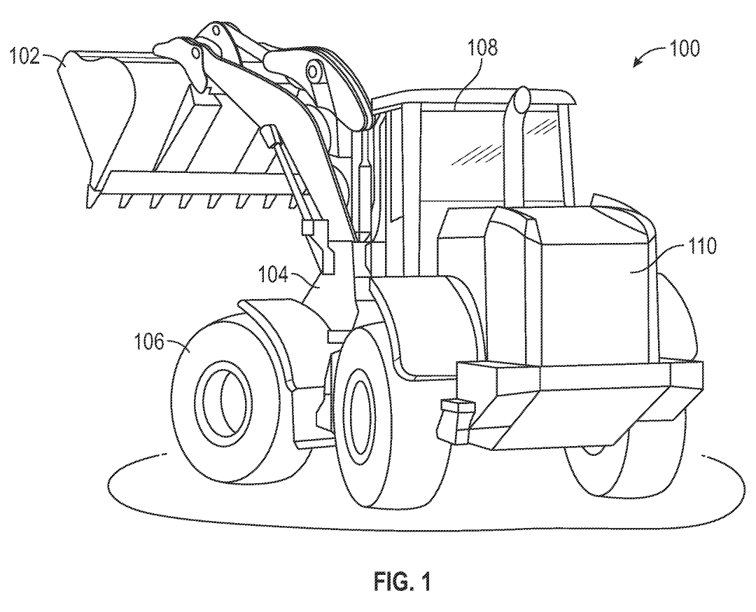

Referring to FIG. 1, an example work vehicle 100 in the form of a self-propelled vehicle (e.g., a wheel loader) houses or otherwise supports a bucket 102 attached to an articulating arm. The work vehicle 100 may incorporate an engine with the disclosed piston and injector. The work vehicle 100 may be either manned or autonomous and is primarily used to scoop or distribute material with the bucket 102. The work vehicle 100 includes a chassis 104 supported by ground-engaging members 106 (e.g., wheels or tracks) and supports a cab 108. The work vehicle 100 also includes an internal combustion engine system 110.

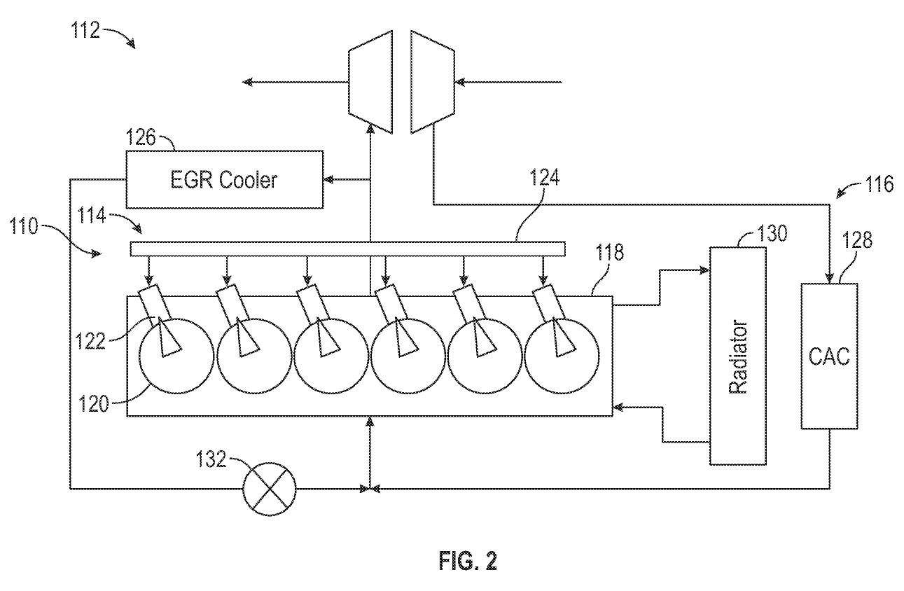

FIG. 2 illustrates a schematic view of the internal combustion engine system 110. The system integrates an exhaust gas recirculation (EGR) system 112, a fuel injection system 114, and cooling components 116 designed for efficient thermal management and emissions optimization. The engine system includes an engine block 118 containing multiple cylinders, such as cylinder 120. Each cylinder is equipped with fuel injectors, including a variable fuel injector assembly 122, which receives fuel from a fuel rail 124. The fuel rail 124 is configured to maintain consistent fuel pressure and flow across all cylinders. Exhaust gases flow through an EGR cooler 126, which reduces the temperature of recirculated exhaust gases before they re-enter the engine block.

The charge air cooler (CAC) 128 is positioned downstream of a turbocharger and thermally connected to a radiator 130. The radiator 130 and CAC 128 function together to dissipate heat, ensuring optimal intake air temperatures for combustion. Coolant flow through the system is managed by a bypass valve 132, which regulates the flow between the EGR cooler 126, the radiator 130, and other thermal management components. The coordinated operation of the fuel rail 124, EGR cooler 126, charge air cooler 128, and bypass valve 132 provides mechanisms for managing emissions and improving engine performance across various operating conditions.

FIG. 3 illustrates a cross-sectional view of piston 134 positioned within cylinder 120 (see FIG. 2), focusing on the interaction between variable fuel injector assembly 122 and combustion bowl 136 of piston 134. The variable fuel injector assembly 122 comprises injector needle 138, nozzle 140, flow passages 142, nozzle orifices 144A-144D, and travel stop 146, which work together to regulate fuel delivery into the combustion area of the piston 134.

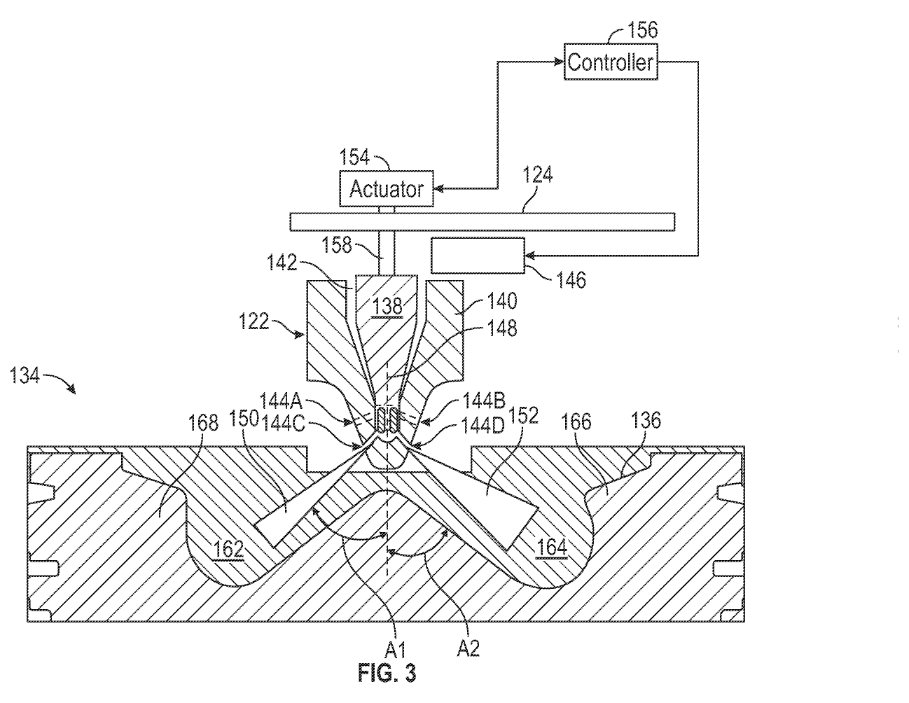

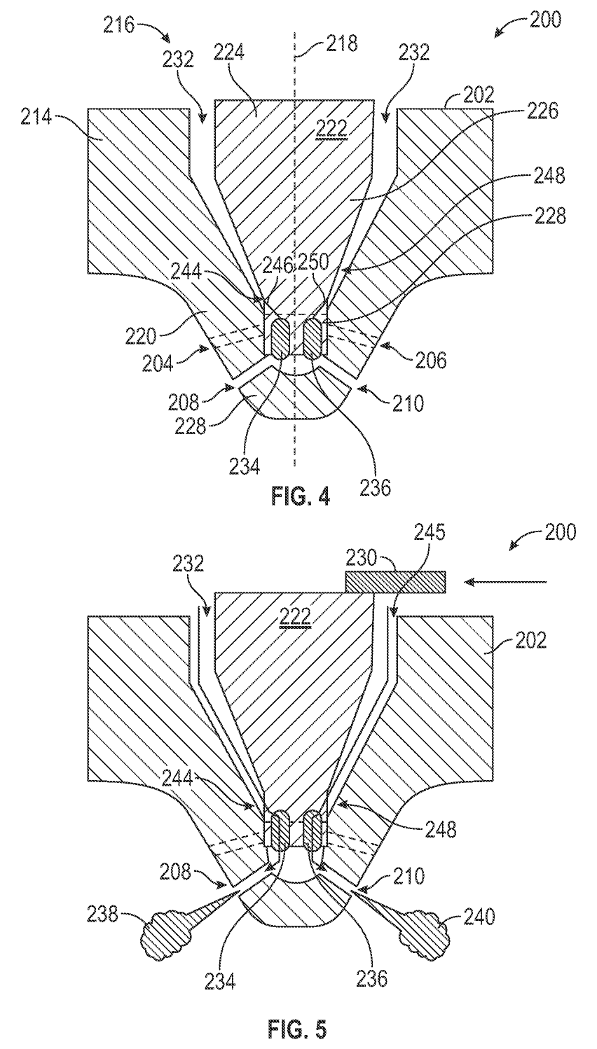

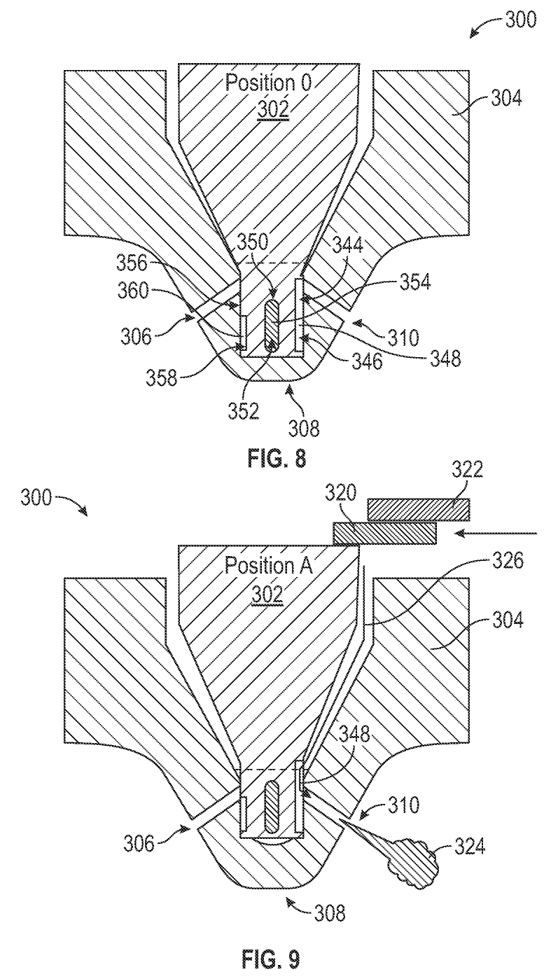

While a specific configuration of nozzle orifices is shown in general in FIG. 3, it will be understood that various groupings of nozzle orifices can be incorporated in the variable fuel injector assembly. Various examples are provided herein, such as with the embodiment of FIGS. 4-7, the embodiment of FIGS. 8-12, and so forth.

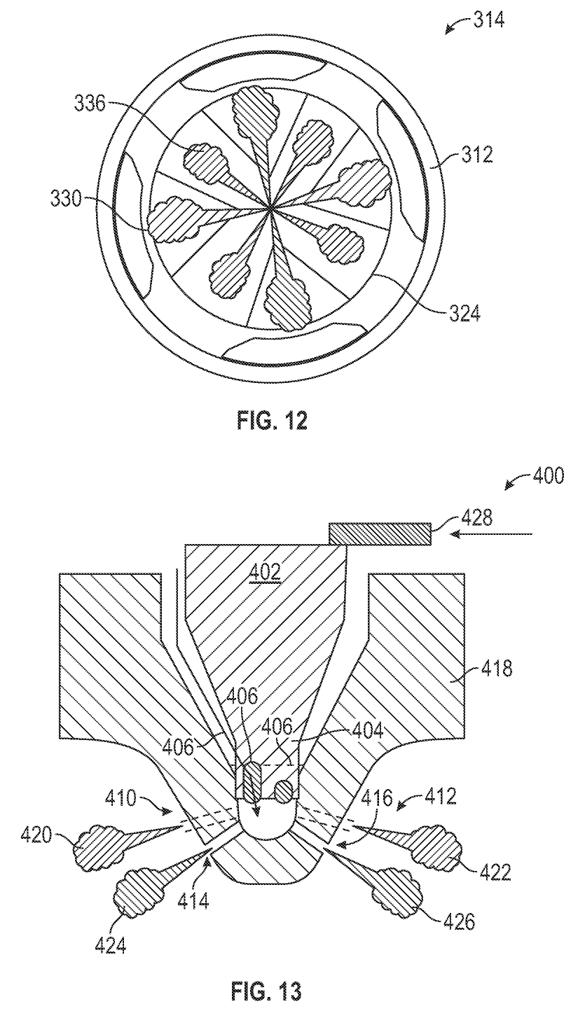

The nozzle orifices 144A-144D are each arranged radially around reference line 148, creating a distribution pattern around the nozzle axis. Each orifice is precisely positioned at a different combination of radial distance from and axial position along reference line 148, creating a three-dimensional arrangement of outlets that optimizes fuel distribution. This strategic positioning ensures uniform fuel delivery into each sector (asymmetric or symmetric) of the combustion bowl 136. Each orifice is machined at a specific radial position and angle relative to reference line 148, enabling the creation of distinct spray patterns 150 and 152 (as well as others that cannot be seen in this view, see FIGS. 7 and 12 for example spray patterns) that effectively target different sectors of the combustion bowl.

The radial positioning of the orifices, combined with their varying axial (vertical) locations along the nozzle body 140, allows for optimized fuel distribution patterns when different groups of orifices are activated through the selective positioning of injector needle 138.

Spray cone angles can be varied across operational ranges through selective nozzle group activation. For example, narrow cone angles may be employed during light load conditions, while wider cone angles optimize fuel distribution under high load. The system enables dynamic selection between distinct spray patterns, potentially combining narrow and wide spray configurations to optimize emissions and performance across the operating envelope.

An actuator 154, controlled by controller 156, dynamically adjusts the position of injector needle 138 within nozzle 140. Fuel is supplied to the injector assembly 122 via fuel rail 124, which maintains consistent pressure throughout operation. The injector needle 138, housed within nozzle 140, moves between closed and open positions, controlling fuel flow through specific nozzle orifices 144. The actuator 154 can include a mechanical coupling 158, such as a shaft that can be moved in a vertical path to move the injector needle 138.

The travel stop 146 regulates the axial movement of the injector needle 138 to control fuel delivery through the nozzle outlets. In one embodiment, the travel stop is implemented as an elongated bar disposed at an angle relative to the nozzle axis (e.g., reference line 148). This angled configuration permits the travel stop 146 to selectively translate along a dedicated stop axis into and out of interference with the translation of the injector needle 138. By translating along a stop axis S, the travel stop 146 can engage or disengage the injector needle 138 at predetermined axial positions, thereby establishing discrete internal flow passages that activate different groups of nozzle outlets.

In certain embodiments, the travel stop 146 is actuated electrically or hydraulically via a solenoid control valve, providing dynamic and remote control over the axial positioning of the injector needle 138. This solenoid-actuated travel stop facilitates rapid adjustments to fuel injection timing and volume in response to real-time engine operating conditions. Moreover, the mechanism may comprise multiple independently movable travel stops—such as a first travel stop 146 and a second travel stop (see FIG. 9 as an example of a device with two travel stops)—each implemented as an angled bar.

In such embodiments, the first travel stop is configured to restrict injector needle movement at an initial axial position, while the second travel stop is arranged downstream along the nozzle axis to engage the injector needle at a further axial position. This dual-stop arrangement enables staged activation of nozzle outlets: when the injector needle 138 abuts the first travel stop 146, only a first set of nozzle outlets is activated; upon translation beyond the first travel stop and engagement with the second travel stop, additional nozzle outlets are opened to allow increased fuel flow.

As noted above, the nozzle orifices 144A, 144B, 144C, and 144D are positioned at different radial distances and axial locations relative to reference line 148, thereby defining distinct spray cone angles A1 and A2. The first spray angle A1 corresponds to spray pattern 150, which is directed into sector 162 of combustion bowl 136. The second spray angle A2 corresponds to spray pattern 152, which is directed into sector 164.

The differentiation between spray angles A1 and A2 allows for optimized fuel-air mixing within symmetrically or asymmetrically shaped sectors of the combustion bowl 136. The narrower spray pattern 150 (associated with A1) ensures that fuel is concentrated within sector 162. Meanwhile, the wider spray pattern 152 (associated with A2) ensures uniform fuel distribution across sector 164.

In general, the combustion bowl 136 of the piston can be configured with either symmetric or asymmetric sectors. In one embodiment, the combustion bowl 136 includes sectors defined by ledges that may vary in geometry; for example, one sector (such as sector 164) may be bounded by a curved ledge 166, while in an alternative embodiment the corresponding ledge 168 of sector 162 is substantially, vertically straight. These variations in combustion bowl geometry enable tailored fuel-air mixing by altering the distribution of fuel delivered by the variable injector assembly 122. The injector assembly, with its selectable spray patterns (for example, spray patterns 150 and 152), is operable in either configuration—symmetric or asymmetric—ensuring that fuel delivery is optimized for the particular thermal and combustion characteristics of the engine regardless of whether the combustion bowl is uniformly shaped or exhibits distinct, asymmetric sectors.

The combustion bowl 136 of the piston can be partitioned into multiple sectors, each defined by a unique profile. In general, the profile of a given sector is determined by a radial arc swept from the center of the combustion bowl—defined by a common reference line 148—outward to the edge of that sector. This approach allows for individual sectors to possess distinct geometries; as a result, the combustion bowl may be entirely symmetric (with all sectors sharing the same profile), entirely asymmetric (with each sector having a unique profile), or partially symmetric, where some sectors are identical while others differ. Such versatility in sector profiles enables the optimization of fuel-air mixing and combustion characteristics tailored to specific engine performance requirements. Moreover, the variable injector assembly is designed to function effectively with either symmetric or asymmetric combustion bowl configurations, ensuring that fuel delivery is precisely modulated in accordance with the unique geometric attributes of each bowl sector.

In operation, FIGS. 4-7 collectively illustrate a variable fuel injector assembly having precisely controlled fuel delivery characteristics. FIG. 4 provides a cross-sectional view of variable fuel injector assembly 200, focusing on nozzle 202 and its internal configuration. The nozzle 202 includes four nozzle orifices, consisting of upper nozzle orifices 204 and 206 and lower nozzle orifices 208 and 210.

The upper nozzle orifices 204 and 206 are positioned closer to the top of nozzle 202 and are part of a first group configured to generate narrower spray patterns for targeted fuel delivery. The lower nozzle orifices 208 and 210, located at the base of nozzle 202, belong to a second group designed to produce wider spray patterns for broader fuel distribution.

The nozzle 202 comprises a nozzle body 212 having a nozzle cavity 214 extending along a nozzle axis that is coextensive with reference axis 216. The nozzle body 212 transitions to a nozzle neck 218, which narrows from the nozzle body 212. A nozzle head 220 extends from the nozzle neck 218 and defines multiple nozzle outlets positioned differently with respect to the nozzle axis 216, including upper nozzle orifices 204, 206 and lower nozzle orifices 208, 210.

The cavity 214 receives an injector needle 222 that reciprocates along the reference axis 216. The injector needle 222 incorporates a needle body 224 that transitions to a needle neck 226, which narrows from the needle body 224, and a needle head 228. While not visible in this cross-sectional view, a travel stop 230 (shown in subsequent figures) is configured and positionable to selectively impede movement of the injector needle 222 along the nozzle axis 216 in a direction away from the nozzle head 220.

Fuel enters the nozzle cavity 214 from an external fuel rail and is directed through internal flow passages 232 that extend between the injector needle 222 and nozzle body 212. The flow passages 232 serve as conduits for pressurized fuel, allowing precise delivery through the active nozzle orifices. These passages are formed within the nozzle structure, ensuring efficient fuel atomization and distribution.

In one embodiment, the injector needle 222 is provided with a first needle inlet 244 formed in the needle head 228 and a corresponding first needle outlet 234, thereby defining a first internal flow passage 246 that conducts pressurized fuel from the first needle inlet 244 to the designated nozzle outlets when the injector needle 222 is in the appropriate axial position. The injector needle 222 includes a second needle inlet 248 formed in the needle body 224 or an adjacent region of the needle head 228, along with a corresponding second needle outlet 236. Together, these features define a second internal flow passage 250 that serves as an additional conduit for pressurized fuel. When the injector needle 222 is translated to a further axial position, the second internal flow passage 250 is activated to deliver fuel to an alternate group of nozzle outlets. This dual needle inlet and outlet configuration, comprising internal flow passages 246 and 250, affords enhanced control over fuel delivery, enabling selective activation of distinct nozzle groups in accordance with the claimed embodiments and facilitating precise modulation of the fuel spray pattern based on the axial position of the injector needle 222.

At the lower portion of nozzle head 220, needle outlets 234 and 236 direct fuel toward specific nozzle orifices 204, 206, 208, and 210 depending on the vertical location of the injector needle 222. These needle outlets regulate the distribution of pressurized fuel, allowing staged activation of nozzle groups depending on the axial position of injector needle 222.

FIG. 5 illustrates a detailed cross-sectional view of variable fuel injector assembly 200 during operation, highlighting the flow of fuel through nozzle 202. The lower nozzle orifices 208 and 210 are active in this configuration, generating spray patterns 238 and 240 that are directed into specific regions of a combustion bowl of a piston.

Pressurized fuel from the fuel rail flows through variable fuel injector assembly 200 and into flow passages 232 between nozzle 202 and injector needle 222. Injector needle 222 is shown in a partially lifted position, allowing fuel to pass through nozzle orifices 208 and 210.

Fuel flow 245 traverses through internal passages between the needled and nozzle. The resulting spray patterns 238 and 240 are directed into sectors of a combustion bowl. In one example, spray pattern 238 targets one region, while spray pattern 240 is aimed at a second region, ensuring precise fuel-air mixing. A controller, connected to an actuator, modulates the lift height of injector needle 222 to regulate fuel flow through nozzle 202. This precise control allows selective activation of nozzle orifices 208 and 210, optimizing fuel delivery for the geometry of combustion bowl 242.

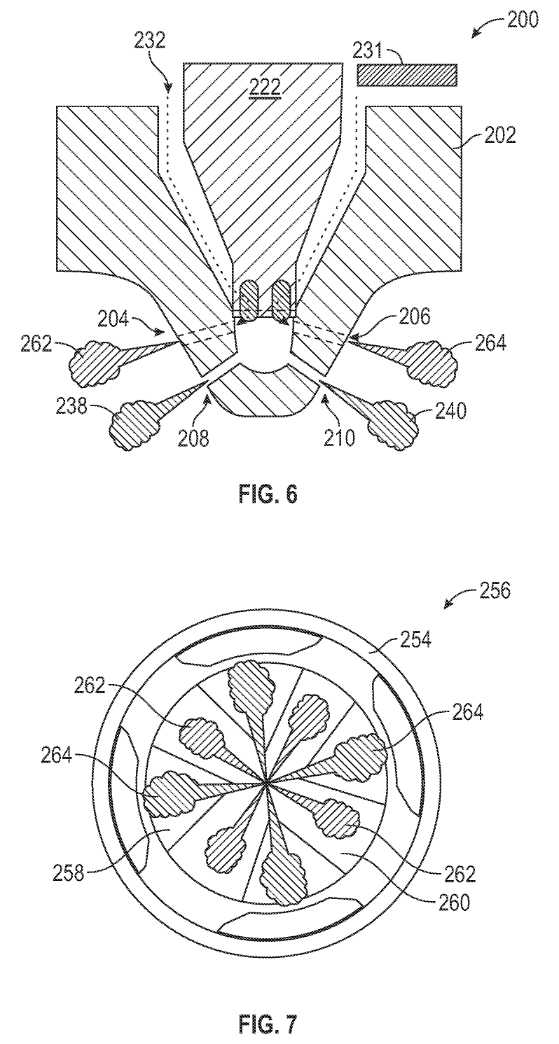

FIG. 6 illustrates a cross-sectional view of variable fuel injector assembly 200 in a configuration where both upper nozzle orifices 204 and 206, as well as lower nozzle orifices 208 and 210, are active. This operation generates four distinct spray patterns: upper spray patterns 262 and 264, and lower spray patterns 238 and 240, each targeting specific regions of a combustion bowl.

Fuel flows from a fuel rail into the variable fuel injector assembly 200, guided through internal flow passages 232 between nozzle 202 and injector needle 222. In this configuration the actuator, controlled by controller 246, has lifted injector needle 222 to an intermediate position that allows fuel to pass through all nozzle orifices 204, 206, 208, and 210. The arrow in FIG. 6 indicates fuel flow 245 through flow passages 232 to the nozzle orifices. A second travel stop 231 is moved by the actuator to permit unrestricted vertical movement of the injector needle 222.

In one example, spray patterns 262 and 264, associated with upper nozzle orifices 204 and 206, produce narrower cone angles for targeted fuel delivery to the shallower regions of a combustion bowl. Meanwhile, spray patterns 238 and 240, associated with lower nozzle orifices 208 and 210, provide broader cone angles, delivering fuel to the deeper sectors of a combustion bowl. The coordination of actuator, injector needle 222, and flow passages 232 enables this dual-group operation, allowing injector assembly 200 to dynamically adapt to varying engine load and operating conditions.

FIG. 7 illustrates a top-down view of a combustion bowl 254 of piston 256, showing the distribution of spray patterns generated by variable fuel injector assembly 200. The four lower spray patterns 238 and 240 and two upper spray patterns 262 and 264, originating from nozzle orifices 208, 210, 204, and 206, respectively, are shown. These spray patterns can be directed into distinct sectors of the combustion bowl 254, such as sector 258 and sector 260.

Spray patterns 238 and 240 are directed toward the deeper regions of combustion bowl 254, ensuring thorough mixing and effective fuel distribution in these areas. Spray patterns 262 and 264 are aimed at the shallower sections of combustion bowl 254, providing fuel delivery tailored to regions with lower thermal loads. The alignment of these spray patterns with the asymmetric geometry of combustion bowl 254 enhances fuel-air mixing and optimizes combustion efficiency.

FIG. 8 illustrates variable fuel injector assembly 300 in Position 0, also referred to as a null axial position, where injector needle 302 is fully closed within nozzle 304. In this configuration, no fuel is delivered through nozzle orifices 306, 308, and 310, as injector needle 302 remains seated, completely blocking fuel flow. The null axial position represents a complete shutdown state, where injector needle 302 is fully seated against nozzle 304, preventing fuel leakage through any nozzle orifices.

The nozzle orifices 306, 308, and 310 are symmetrically positioned at the base of nozzle 304 and are responsible for directing fuel into combustion bowl 312 of piston 314 during active injection states (see FIG. 12). However, in Position 0, injector needle 302 ensures that no fuel enters combustion bowl 312, preventing premature fuel mixing.

An actuator maintains injector needle 302 in the closed position, ensuring that injector assembly 300 remains pressurized but inactive, allowing for precise and controlled fuel injection in subsequent phases. A travel stop mechanism regulates the movement of injector needle 302. The travel stops 320 and 322 (shown in subsequent figures) control the axial displacement of injector needle 302, limiting fuel flow through different nozzle orifices at varying lift heights. The nozzle orifices 306, 308, and 310, as well as the internal sealing surface of nozzle 304, are precision-machined to maintain a high-pressure seal, ensuring efficient injector operation and eliminating fuel leakage when the system is inactive.

The injector needle 302 is further configured with dedicated needle inlets and corresponding needle outlets that establish distinct internal flow paths for pressurized fuel. For example, a first needle inlet 344 is provided in the upper region of the injector needle 302, with a corresponding first needle outlet 346 formed in the adjacent portion of the needle head. These features define a first internal flow path 348 that directs fuel from the first needle inlet 344 to nozzle orifice 310, thereby supplying fuel when the injector needle 302 is in Position A.

In embodiments corresponding to the higher lift Position C, the injector needle 302 further comprises a second needle inlet 350, located in the midsection of the needle, with a corresponding second needle outlet 352 that together define a second internal flow path 354. This second flow path channels additional fuel through internal flow passage 334 to nozzle orifice 308. Optionally, a third needle inlet 356 and its corresponding third needle outlet 358 may be provided in the lower region of the injector needle 302, thereby establishing a third internal flow path 360 that becomes active when the injector needle 302 is fully lifted beyond travel stop 322 (see FIG. 9), delivering fuel through internal flow passage 340 to nozzle orifice 306. In some embodiments, a reduced diameter section 362 is formed in the needle head 302, which contributes to the formation of the third internal flow path 360 by providing a constricted region that accelerates fuel flow and enhances atomization. This reduced diameter section 362 further distinguishes the third flow path from the first and second flow paths, thereby facilitating precise modulation of fuel delivery through nozzle orifice 306. Collectively, the arrangement of multiple needle inlets and outlets—with their respective flow paths 348, 354, and 360—and the incorporation of a reduced diameter section 362 enables the injector assembly to selectively modulate fuel delivery to distinct nozzle outlets in accordance with the axial position of the injector needle 302, thus facilitating the generation of discrete spray patterns for optimized combustion under varying operating conditions.

FIG. 9 illustrates variable fuel injector assembly 300 in Position A, where injector needle 302 is partially lifted from nozzle 304, permitting fuel flow 326 through internal flow path 348 toward nozzle orifice 310, while nozzle orifices 306 and 308 remain sealed. The travel stop 320 is engaged in Position A, limiting the lift height of injector needle 302 and ensuring that only nozzle orifice 310 is activated. This restricted fuel flow produces spray pattern 324, which is directed into a specific region of a combustion bowl.

The fuel flow 326 is indicated by arrows in FIG. 9, showing how pressurized fuel moves through internal flow passages and is atomized as it exits nozzle orifice 310. This controlled delivery of fuel optimizes combustion efficiency, particularly during low-load operating conditions where reduced fuel injection is necessary. An actuator, under the regulation of controller, ensures precise needle positioning in Position A, controlling the amount of fuel delivered to the combustion chamber.

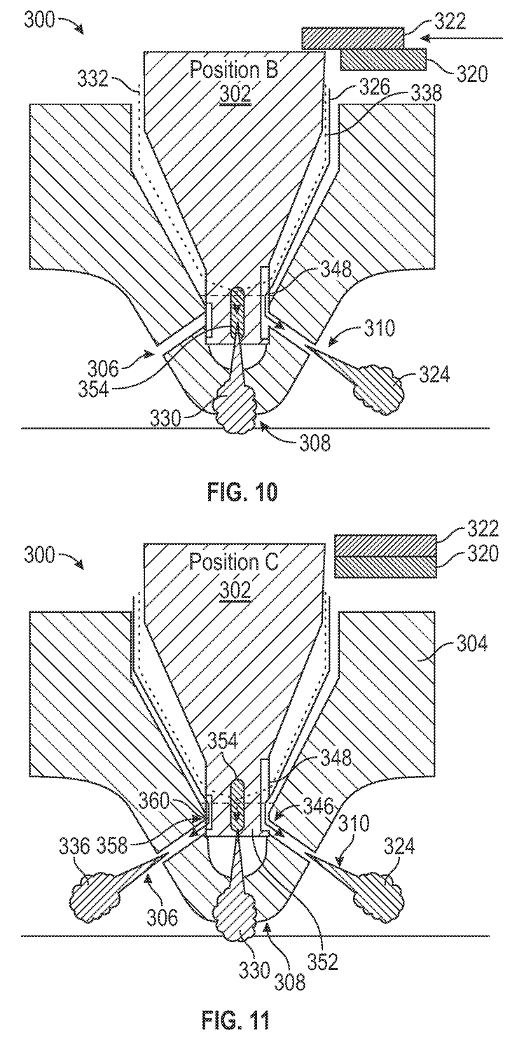

FIG. 10 illustrates variable fuel injector assembly 300 in Position B, where injector needle 302 is lifted further than in Position A, allowing fuel to flow through two nozzle orifices, 308 and 310. This configuration generates two distinct spray patterns, 324 and 330, directed into a combustion bowl.

In Position B, injector needle 302 is lifted beyond travel stop 320, permitting fuel to reach both nozzle orifices 308 and 310, while nozzle orifice 306 remains closed. The fuel flows 326 and 332 indicate how pressurized fuel travels through internal flow passages 348 and 354 in the injector needle 302, reaching the respective nozzle orifices.

FIG. 11 illustrates variable fuel injector assembly 300 in Position C, where injector needle 302 is fully lifted within nozzle 304, permitting fuel flow through all three nozzle orifices: 306, 308, and 310. This state generates three distinct spray patterns: 324, 330, and 336, optimizing fuel distribution for high-load operation.

In Position C, injector needle 302 moves past both travel stops 320 and 322, fully opening nozzle orifices 306, 308, and 310. The arrows in FIG. 11 illustrate the fuel flow paths 326, 332, and 338, directing pressurized fuel through internal flow passages 348, 354, and 360 toward the combustion chamber.

Spray pattern 324 exits nozzle orifice 310, targeting the outer region of combustion bowl 312. Spray pattern 330 exits nozzle orifice 308, targeting the central region, while spray pattern 336 exits nozzle orifice 306, reaching an additional peripheral region.

In more detail, fuel flows through the first internal flow path 348 to needle outlet 346 to produce spray pattern 324 out of nozzle outlet 310. Fuel flows through the second internal flow path 354 to needle outlet 352 to produce spray pattern 330 out of nozzle outlet 308, and fuel flows through the third internal flow path 360 to needle outlet 358 to produce spray pattern 336 out of nozzle outlet 306.

The relative positions of travel stops 320 and 322 allow injector needle 302 to fully lift in Position C, engaging all nozzle orifices simultaneously. This coordinated spray pattern arrangement ensures optimized fuel-air mixing, promoting efficient combustion while addressing asymmetries in the combustion bowl geometry.

FIG. 12 provides a top-down view of combustion bowl 312 of piston 314, showing the distribution of spray patterns from variable fuel injector assembly 300 in Position C. The three spray patterns: 324, 330, and 336, originate from nozzle orifices 310, 308, and 306, respectively (see FIG. 11). Spray pattern 324 is directed toward a peripheral region, spray pattern 330 targets the central region, and spray pattern 336 is directed toward an opposing peripheral region.

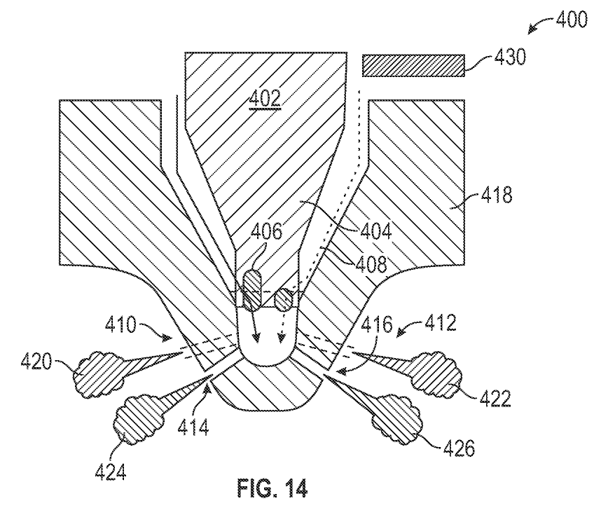

FIG. 13 illustrates a high-flow configuration of variable fuel injector assembly 400, focusing on the design of injector needle 402 and its outlet configuration. The lower portion of the needle head 404 incorporates two distinct outlet groups: primary outlets 406 and secondary outlets 408. The primary outlets 406 are configured to provide a lower flow rate, while the secondary outlets 408 are designed to deliver a higher flow rate when uncovered.

The assembly further comprises four nozzle orifices—410, 412, 414, and 416—positioned at the base of the nozzle body 418. These orifices generate four distinct spray patterns: spray pattern 420 emanates from nozzle orifice 410 toward an outer region; spray pattern 422 from nozzle orifice 412 is directed toward an intermediate region; spray pattern 424 from nozzle orifice 414 is aimed at the central region; and spray pattern 426 from nozzle orifice 416 is directed toward another intermediate region. When injector needle 402 is fully raised in the high-flow configuration, both the primary outlets 406 and the secondary outlets 408 are uncovered, allowing fuel to flow through all four nozzle orifices and thereby generating spray patterns 420, 422, 424, and 426. In this state, travel stops 428 and 430 are fully retracted, permitting maximum axial movement of the injector needle 402.

FIG. 14 illustrates injector needle 402 in a partially raised position. In this configuration, only the primary outlets 406 are uncovered, restricting fuel flow to nozzle orifices 410 and 412 and thereby activating spray patterns 420 and 422. Specifically, spray pattern 420, which exits nozzle orifice 410, is directed toward an outer region, while spray pattern 422, emerging from nozzle orifice 412, is directed toward an intermediate region. In this partially raised state, nozzle orifices 414 and 416, along with their associated spray patterns 424 and 426, remain inactive.

The engagement of travel stop 430 in this position limits the axial movement of injector needle 402, ensuring that only the primary outlets 406 are active. By selectively raising or lowering injector needle 402, the injector assembly 400 can transition between high-flow and low-flow configurations. This dynamic adjustment of the fuel spray pattern in response to varying engine load conditions enhances fuel-air mixing and combustion efficiency. The coordinated interaction among the primary outlets 406, the secondary outlets 408, and the axial movement of injector needle 402 enables precise control over fuel injection timing and volume, thereby reducing emissions and improving overall engine performance.

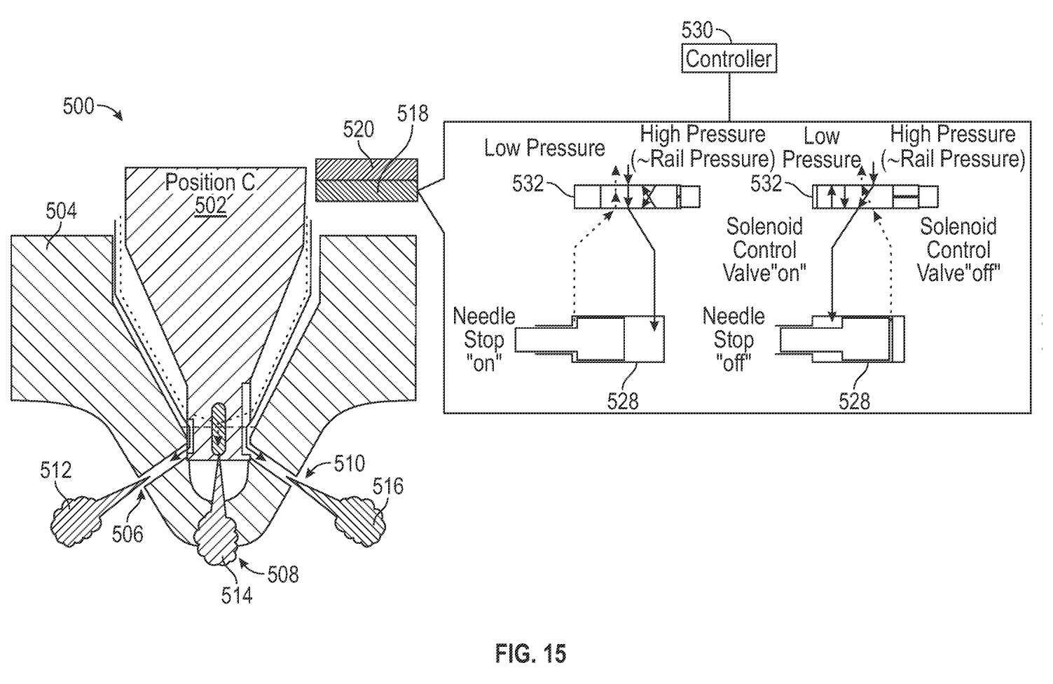

FIG. 15 illustrates a variable fuel injector system 500 operating in Position C, where the injector needle 502 is fully lifted within the nozzle body 504. This configuration allows fuel to flow through three nozzle orifices, identified as 506, 508, and 510, generating corresponding spray patterns 512, 514, and 516. Spray pattern 512 exits nozzle orifice 506 and is directed toward one region of the combustion chamber. Spray pattern 514, originating from nozzle orifice 508, is directed toward another region, while spray pattern 516, exiting nozzle orifice 510, is directed to an additional region.

The travel stops 518 and 520 are fully retracted in Position C, enabling the injector needle 502 to achieve maximum axial movement and activate all nozzle orifices simultaneously. Fuel is delivered to the nozzle orifices via internal flow passages 522, 524, and 526, ensuring consistent and precise delivery for optimal combustion.

The hydraulic control system includes a solenoid control valve 528, which is connected to high-pressure (~rail pressure) and low-pressure fuel lines. The solenoid control valve 528 controls the travel stop mechanism by selectively applying high or low pressure to adjust the stop position. When the solenoid valve 528 is in the "on" state, the travel stop mechanism engages, restricting needle movement and limiting fuel flow to specific spray patterns. When the solenoid valve 528 is in the "off" state, the travel stop mechanism is disengaged, allowing full axial movement of the injector needle 502 and enabling high-flow operation.

A controller 530 dynamically adjusts the solenoid control valve 528 and the position of the injector needle 502 based on engine operating conditions, such as load and speed. This adaptive system allows the injector assembly 500 to adjust injection parameters, including flow rate and spray angle, to meet the performance requirements of varying operating conditions and optimize combustion efficiency.

The fuel rail 532 supplies pressurized fuel to the injector assembly 500, maintaining consistent high-pressure delivery for optimal operation. The solenoid control valve 528 regulates the pressure within the system by dynamically connecting the fuel rail 532 to both high-pressure and low-pressure fuel lines. In its "on" state, the solenoid valve 528 directs high-pressure fuel from the rail 532 to engage the travel stops 518 and 520, restricting the axial movement of the injector needle 502 and controlling the activation of specific nozzle orifices. When the solenoid valve 528 is in its "off" state, it releases pressure from the travel stops, allowing the injector needle 502 to achieve full axial movement. Excess fuel or pressure within the system is routed back to the fuel rail 532 via the low-pressure return line, ensuring stable operation and efficient pressure management throughout the injection process.

### CONCLUSION

The present disclosure provides an integrated system comprising variable fuel injector designs and asymmetric piston bowl geometries to optimize combustion efficiency, thermal management, and emissions reduction in internal combustion engines. By enabling precise control of injection parameters—such as flow rates, cone angles, and active injection orifices—the variable injector assembly dynamically adapts fuel delivery to meet varying engine demands. When paired with the asymmetric piston bowl, featuring distinct regions designed to promote efficient fuel-air mixing and direct combustion gases away from thermally sensitive areas, the system reduces localized heat buildup and minimizes thermal stresses in critical components, such as the cylinder head and exhaust valves.

As utilized herein, unless otherwise limited or modified, lists with elements that are separated by conjunctive terms (e.g., "and") and that are also preceded by the phrase "one or more of" or "at least one of" indicate configurations or arrangements that potentially include individual elements of the list, or any combination thereof. For example, "at least one of A, B, and C" or "one or more of A, B, and C" indicates the possibilities of only A, only B, only C, or any combination of two or more of A, B, and C (e.g., A and B; B and C; A and C; or A, B, and C). Also, the use of “one or more of” or “at least one of” in the claims for certain elements does not imply other elements are singular nor has any other effect on the other claim elements.

As utilized herein, the singular forms "a", "an," and "the" are intentionally-grown to include the plural forms as well, unless the context clearly indicates otherwise. It will be further understood that the terms "comprises" and/or "comprising," when utilized in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intentionally-grown to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s). Accordingly, various embodiments and implementations other than those explicitly described are within the scope of the following claims.

What is claimed is:

1. A fuel injector comprising:
a nozzle defining a nozzle cavity extending about a nozzle axis, the nozzle cavity having a nozzle body, a nozzle neck that narrows from the nozzle body, and a nozzle head extending from the nozzle neck and defining multiple nozzle outlets positioned differently with respect to the nozzle axis;
an injector needle disposed in the nozzle cavity and movable along the nozzle axis, the injector needle having a needle body, a needle neck that narrows from the needle body; and
a travel stop configured and positionable to selectively impede movement of the injector needle along the nozzle axis in a direction away from the nozzle head so that the injector needle may translate along the nozzle axis between a first axial position and a second axial position, in the first axial position, the injector needle abuts the travel stop and allows flow to a first of the nozzle outlets, and, in the second axial position, the injector needle is clear of the travel stop and allows flow to a first of the nozzle outlets and a second of the nozzle outlets.

2. The fuel injector of claim 1, wherein, in the first axial position, the injector needle opens a first flow path to the first of the nozzle outlets, the first flow path defined in part by a first internal flow passage leading from a first needle inlet in the needle body, the needle neck, or needle head to a first needle outlet in the needle head.

3. The fuel injector of claim 2, wherein, in the second axial position, the injector needle opens the first flow path to second of the nozzle outlets.

4. The fuel injector of claim 3, wherein, in the second axial position, the injector needle opens the flow path to the first and second of the nozzle outlets, the flow path defined in part by the first internal flow passage leading from the first needle inlet to the first needle outlet and by a second internal flow passage leading from a second needle inlet in the needle body, the needle neck, or the needle head to a second needle outlet in the needle head.

5. The fuel injector of claim 3, wherein the nozzle outlets are grouped into a first group of nozzle outlets including first of the nozzle outlets and a second group of nozzle outlets including the second of the nozzle outlets;
wherein the injector needle defines a second internal flow passage leading from a second needle inlet to a second needle outlet, the first and second needle outlets communicating with the first group of nozzle outlets in the first axial position; and
wherein the first and second needle outlets communicate with the first and second groups of nozzle outlets in the first axial position.

6. The fuel injector of claim 1, wherein, in the first axial position, the injector needle opens a first flow path leading to the first of the nozzle outlets, the first flow path defined in part between the needle neck and a needle head, and the nozzle neck and the nozzle head.

7. The fuel injector of claim 6, wherein, in the second axial position, the injector needle opens a second flow path to the second of the nozzle outlets, the second flow path defined in part by a second internal flow passage passing from a needle inlet in the needle body, the needle neck, or the needle head to a first needle outlet in the needle head that communicates with the second of the nozzle outlets.

8. The fuel injector of claim 7, wherein, in the second axial position, the injector needle opens the second flow path to the first and second of the nozzle outlets, the flow path defined in part by a first internal flow passage leading from a first needle inlet to the first needle outlet and by a second internal flow passage leading from a second needle inlet in the needle body, the needle neck, or the needle head to the first needle outlet in the needle head.

9. The fuel injector of claim 7, further including a second travel stop configured and positionable to selectively impede movement of the injector needle along the nozzle axis in a direction away from the nozzle head so that the injector needle may translate along the nozzle axis between the second axial position and a third axial position; and
wherein, in the second axial position, the injector needle is clear of the travel stop and abuts the second travel stop and, in the third axial position, the injector needle is clear of the travel stop and the second travel stop and allows flow to the first of the nozzle outlets, the second of the nozzle outlets, and a third of the nozzle outlets.

10. The fuel injector of claim 9, wherein, in the third axial position, the injector needle opens a third flow path leading to the third of the nozzle outlets, the third flow path defined in part between the needle neck and the needle head and the nozzle neck and the nozzle head, including a reduced diameter section of the needle head.

11. The fuel injector of claim 9, wherein the nozzle outlets are grouped into a first group of nozzle outlets including the first of the nozzle outlets, a second group of nozzle outlets including the second of the nozzle outlets, and a third group of nozzles including the third of the nozzle outlets.

12. The fuel injector of claim 1, wherein, in the first axial position, the injector needle opens a flow path to the first of the nozzle outlets, the flow path defined in part by a first internal flow passage leading from a first needle inlet in the needle body, the needle neck, or a needle head to the nozzle outlets;
wherein, in the second axial position, the injector needle opens the flow path to the first and second of the nozzle outlets, the flow path defined in part by the first internal flow passage and a second internal flow passage leading from a second needle inlet in the needle body, the needle neck, or the needle head to the nozzle outlets; and
wherein the second needle inlet is closer to a distal end of the nozzle head than the first needle inlet such that, in the first axial position, the first needle inlet is open to the nozzle outlets and the second needle inlet is closed off by the nozzle head and, in the second axial position, the first needle inlet and the second needle inlet are open to the nozzle outlets.

13. The fuel injector of claim 12, wherein the injector needle allows more flow through the nozzle outlets in the first axial position than in the second axial position.

14. The fuel injector of claim 1, wherein the injector needle may translate along the nozzle axis to a null axial position in which the injector needle is clear of the travel stop and closes of flow to the nozzle outlets.

15. The fuel injector of claim 1, wherein the travel stop is a bar disposed at an able to the nozzle axis and configured to selectively translate along a stop axis into and out of interference with translation of the injector needle along the nozzle axis.

16. The fuel injector of claim 15, wherein the travel stop is a solenoid which is electrically or hydraulically actuated.

17. The fuel injector of claim 16, wherein the travel stop includes multiple bars that effect at least two travel stops and which are independently movable into and out of interference with translation of the injector needle along the nozzle axis; and
wherein a first travel stop is positioned to intersect the nozzle axis closer to the nozzle head than a second travel stop.

18. A fuel system for a work vehicle, comprising:
a fuel rail configured to supply pressurized fuel to a variable fuel injector assembly, the variable fuel injector assembly comprising:
an injector needle configured to move along an axis within the variable fuel injector assembly
one or more nozzle orifices grouped into a plurality of nozzle groups, each nozzle group being configured to produce a distinct spray pattern;
a stop mechanism operatively coupled to the injector needle, the stop mechanism being configured to restrict axial movement of the injector needle to predefined intermediate positions, thereby controlling which nozzle groups are activated during operation; and
an actuator operatively coupled to the injector needle, the actuator being configured to dynamically adjust an axial position of the injector needle in response to control signals from a controller;
a controller operatively coupled to the actuator and the stop mechanism, the controller being configured to:
receive input signals indicative of operating conditions of the work vehicle, including engine load, speed, temperature, and aftertreatment system requirements;
generate control signals to adjust an axial position of the injector needle to selectively activate one or more nozzle groups; and
modulate fuel injection parameters, including spray angle, flow rate, and a number of active nozzle orifices, to adapt fuel delivery to varying engine operating conditions;
wherein the variable fuel injector assembly is configured to operate in a low-flow mode by limiting needle movement to a position where only a first nozzle group is activated, the first nozzle group being configured to deliver a narrow spray pattern for targeted combustion during low-load conditions; and operate in a high-flow mode by allowing unrestricted movement of the injector needle to activate multiple nozzle groups, delivering broader spray patterns to accommodate high-load conditions and promote uniform air-fuel mixing.

19. The fuel system of claim 18, wherein the variable fuel injector assembly further comprises a plurality of nozzle orifices arranged in a geometric pattern to optimize spray targeting within an asymmetric piston bowl of a piston, the geometric pattern being configured to direct specific spray patterns to distinct sectors of the asymmetric piston bowl.

20. The fuel system of claim 18, further comprising a piston that includes a combustion bowl comprising at least two asymmetric sectors, each sector having a distinct geometry, wherein the variable fuel injector assembly is configured to selectively deliver fuel to the at least two asymmetric sectors, using spray patterns tailored to geometric characteristics of each sector.
